(19) United States
(12) Patent Application Publication
(10) Pub. No.: US 2008/0002864 A1
(43) Pub. Date: Jan. 3, 2008

(54) USING BACKGROUND FOR SEARCHING IMAGE COLLECTIONS

(75) Inventors: Madirakshi Das, Rochester, NY (US); Andrew C. Gallagher, Pittsburgh, PA (US); Alexander C. Loui, Penfield, NY (US)

Correspondence Address: EASTMAN KODAK COMPANY;PATENT LEGAL STAFF, 343 STATE STREET, ROCHESTER, NY, 14650-2201, US

(73) Assignee: Eastman Kodak Company

(21) Appl. No.: 11/427,352

(22) Filed: Jun. 29, 2006

(51) Int. Cl. G06K 9/00; G06K 9/34

(52) U.S. Cl. 382/118; 382/173

(57) ABSTRACT

A method of identifying a particular background feature in a digital image, and using such feature to identify images in a collection of digital images that are of interest, includes using the digital image for determining one or more background region(s), with the rest of the image region being the non-background region; analyzing the background region(s) to determine one or more features which are suitable for searching the collection; and using the one or more features to search the collection and identifying those digital images in the collection that have the one or more features.

### FIELD OF THE INVENTION

The invention relates generally to the field of digital image processing, and in particular to a method for grouping images by location based on automatically detected backgrounds in the image.

### BACKGROUND OF THE INVENTION

The proliferation of digital cameras and scanners has lead to an explosion of digital images, creating large personal image databases where it is becoming increasingly difficult to find images. In the absence of manual annotation specifying the content of the image (in the form of captions or tags), the only dimension the user can currently search along is time—which limits the search functionality severely. When the user does not remember the exact date a picture was taken, or if the user wishes to aggregate images over different time periods (e.g. images taken at Niagara Falls across many visits over the years, images of person A), he/she would have to browse through a large number of irrelevant images to extract the desired image(s). A compelling alternative is to allow searching along other dimensions. Since there are unifying themes, such as the presence of a common set of people and locations, throughout a user's image collection; people present in images and the place where the picture was taken are useful search dimensions. These dimensions can be combined to produce the exact sub-set of images that the user is looking for. The ability to retrieve photos taken at a particular location can be used for image search by capture location (e.g. find all pictures taken in my living room) as well as to narrow the search space for other searches when used in conjunction with other search dimensions such as date and people present in images (e.g. looking for the picture of a friend who attended a barbecue party in my backyard).

In the absence of Global Positioning System (GPS) data, the location the photo was taken can be described in terms of the background of the image. Images with similar backgrounds are likely to have been taken at the same location. The background could be a living room wall with a picture hanging on it, or a well-known landmark such as the Eiffel tower.

There has been significant research in the area of image segmentation where the main segments in an image are automatically detected (for example, “Fast Multiscale Image Segmentation” by Sharon et al in proceedings of IEEE Conf. on Computer Vision and Pattern Recognition, 2000), but no determination is made on whether the segments belong to the background. Segmentation into background and non-background has been demonstrated for constrained domains such as TV news broadcasts, museum images or images with smooth backgrounds. A recent work by S. Yu and J. Shi (“Segmentation Given Partial Grouping Constraints” in IEEE Transactions on Pattern Analysis and Machine Intelligence, February 2004), shows segregation of objects from the background without specific object knowledge. Detection of main subject regions is also described in commonly assigned U.S. Pat. No. 6,282,317 entitled “Method for Automatic Determination of Main Subjects in Photographic Images” by Luo et al. However, there has been no attention focused on the background of the image. The image background is not simply the image regions left when the main subject regions are eliminated; main subject regions can also be part of the background. For example, in a picture of the Eiffel Tower, the tower is the main subject region; however, it is part of the background that describes the location the picture was taken.

### SUMMARY OF THE INVENTION

The present invention discloses a method of identifying a particular background feature in a digital image, and using such feature to identify images in a collection of digital images that are of interest, comprising:

a) using the digital image for determining one or more background regions and one or more non-background region(s);

b) analyzing the background region(s) to determine one or more features which are suitable for searching the collection; and

c) using the one or more features to search the collection and identifying those digital images in the collection that have the one or more features.

Using background and non-background regions in digital images allows a user to more easily find images taken at the same location from an image collection. Further, this method facilitates annotating the images in the image collection. Furthermore, the present invention provides a way for eliminating non-background objects that commonly occur in images in the consumer domain.

### BRIEF DESCRIPTION OF THE DRAWINGS

FIG. 1 is a flowchart of the basic steps of the method of the present invention;

FIG. 2 shows more detail of block 10 from FIG. 1;

FIG. 3 is an illustration showing the areas in an image hypothesized to be the face area, the clothing area and the background area based on the eye locations produced by automatic face detection; and

FIG. 4 is a flowchart of the method for generating, storing and labeling groups of images identified as having similar backgrounds.

### DETAILED DESCRIPTION OF THE INVENTION

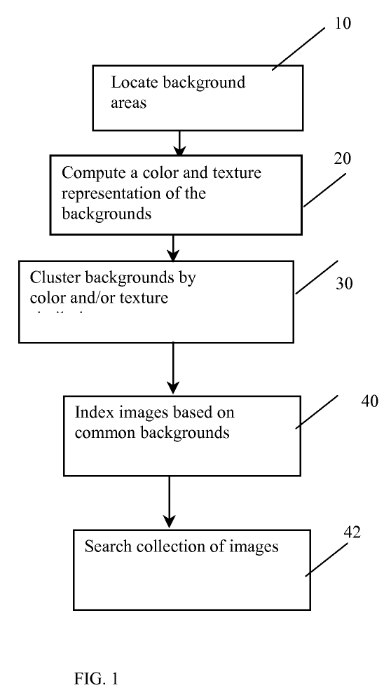

The present invention can be implemented in computer systems as will be well known to those skilled in the art. The main steps in automatically indexing a user's image collection by the frequently occurring picture-taking locations (as shown in FIG. 1) are as follows:

(1) Locating the background areas in images 10;

(2) Computing features (color and texture) describing these background areas 20;

(3) Clustering common backgrounds based on similarity of color or texture or both 30;

(4) Indexing images based on common backgrounds 40; and

(5) Searching the image collections using the indexes generated 42.

As used herein, the term “image collection” refers to a collection of a user's images and videos. For convenience, the term “image” refers to both single images and videos. Videos are a collection of images with accompanying audio and sometimes text. The images and videos in the collection often include metadata.

The background in images is made up of the typically large-scale and immovable elements in images. This excludes mobile elements such as people, vehicles, animals, as well as small objects that constitute an insignificant part of the overall background. Our approach is based on removing these common non-background elements from images—the remaining area in the image is assumed to be the background.

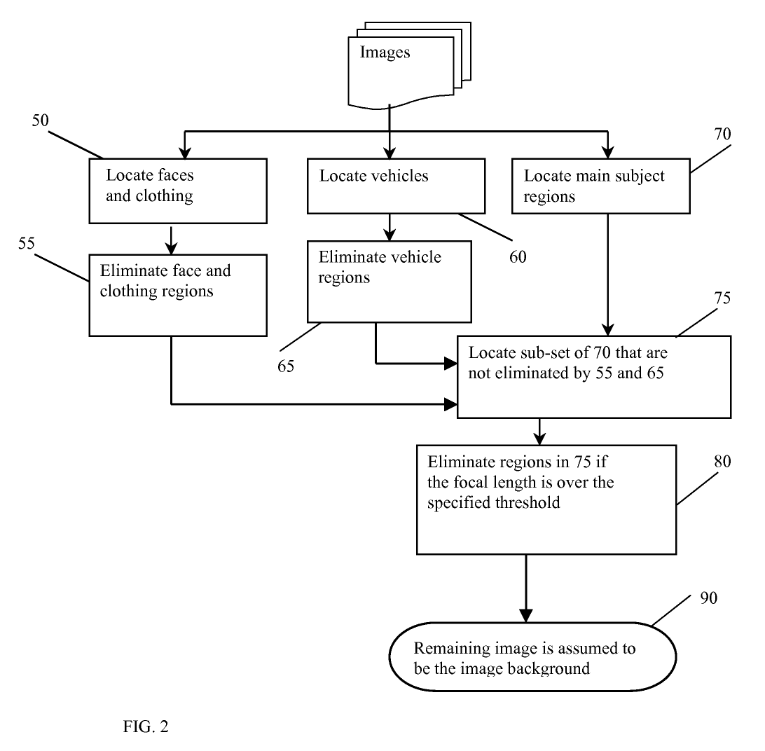

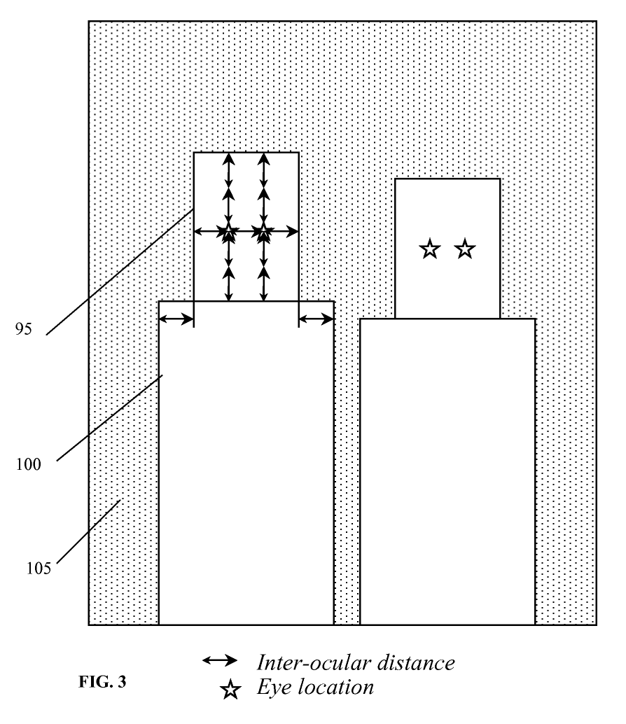

Referring to FIG. 2, images are processed to detect people 50, vehicles 60 and main subject regions 70. Since the end user of image organization tools will be consumers interested in managing their family photographs, photographs containing people form the most important component of these images. In such people images, removing the regions in the image corresponding to faces and clothing leaves the remaining area as the background. Referring to FIG. 2, human faces are located 50 in the digital images. There are a number of known face detection algorithms that can be used for this purpose. In a preferred embodiment, the face detector described in “Probabilistic Modeling of Local Appearance and Spatial Relationships for Object Recognition”, H. Schneiderman and T. Kanade, Proc. of CVPR '98, pp. 45-51 is used. This detector implements a Bayesian classifier that performs maximum a posterior (MAP) classification using a stored probability distribution that approximates the conditional probability of face given image pixel data. The face detector outputs the left and right eye locations of faces found in the image(s). FIG. 3 shows the areas in the image hypothesized to be a face region 95, a clothing region 100 and a background region 105 based on the eye locations produced by the face detector. The sizes are measured in terms of the inter-ocular distance, or 10D (distance between the left and right eye location). The face region 95 covers an area of three times 10D by four times 10D as shown. The clothing region 100 covers five times 10D and extends to the bottom of the image. The remaining area in the image is treated as the background region 105. Note that some clothing region 100 can be covered by other faces and clothing areas corresponding to those faces.

Referring to FIG. 2, vehicle regions 60 are detected using the method described in “Car Detection Based on Multi-Cues Integration” by Zhu et al in Proceedings of the 17^{th} International Conference on Pattern Recognition, 2004 for detecting cars in outdoor still images. In this method, global structure cues and local texture cues from areas of high response to edge and corner point templates designed to match cars, are used to train a SVM classifier to detect cars.

Referring to FIG. 2, the main subject regions in the images are detected 70 using the method described in commonly assigned U.S. Pat. No. 6,282,317 B1 entitled “Method for Automatic Determination of Main Subjects in Photographic Images”. This method performs perceptual grouping on low-level image segments to form larger segments corresponding to physically coherent objects, and uses structural and semantic saliency features to estimate a belief that the region is the main subject using a probabilistic reasoning engine. The focal length registered in the EXIF metadata associated with the image is considered to be a proxy for the distance of the subject from the camera. A threshold (say, 10 mm) is used to separate main subjects that are not in the background from main subjects that are further away and therefore, more likely to be a part of the background. If the focal length is greater than the threshold, the main subject regions remaining in the image are eliminated. This would eliminate objects in the image that are too close to the camera to be considered to be a part of the background.

Referring to FIG. 2, the face and clothing regions, vehicle regions and main subject regions that are closer than a specified threshold are eliminated from the images 55, 65, 80, and the remaining image is assumed to be the image background 90.

To make the background description more robust, backgrounds from multiple images which are likely to have been taken at the same location are merged. Backgrounds are more likely to be from the same location when they were detected in images taken as part of the same event. A method for automatically grouping images into events and sub-events based on date-time information and color similarity between images is described in U.S. Pat. No. 6,606,411 B1, to Loui and Pavie (which is hereby incorporated herein by reference). The event-clustering algorithm uses capture date-time information for determining events. Block-level color histogram similarity is used to determine sub-events. Each sub-event extracted using U.S. Pat. No. 6,606,411 has consistent color distribution, and therefore, these pictures are likely to have been taken with the same background.

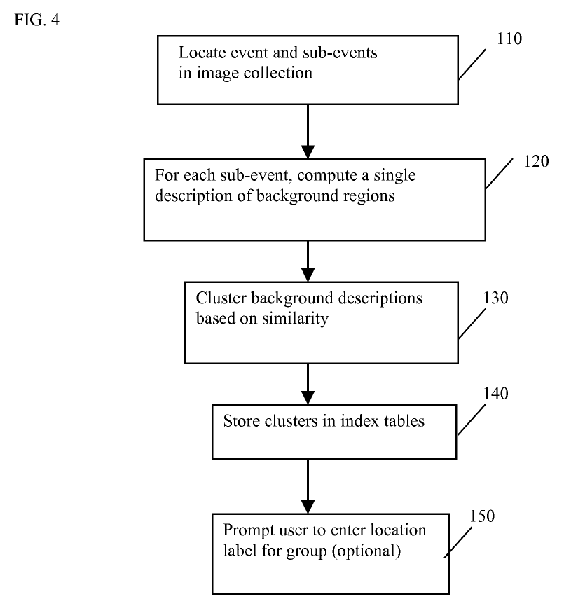

Referring to FIG. 4, the user's image collection is divided into events and sub-events 110 using the commonly-assigned method described by Loui et al in U.S. Pat. No. 6,606,411. For each sub-event, a single color and texture representation is computed for all background regions from the images in the sub-event taken together 120. The color and texture are separate features which will be searched in the one or more background regions. The color and texture representations and similarity are derived from commonly-assigned U.S. Pat. No. 6,480,840 by Zhu and Mehrotra. According to their method, the color feature-based representation of an image is based on the assumption that significantly sized coherently colored regions of an image are perceptually significant. Therefore, colors of significantly sized coherently colored regions are considered to be perceptually significant colors. Therefore, for every input image, its coherent color histogram is first computed, where a coherent color histogram of an image is a function of the number of pixels of a particular color that belong to coherently colored regions. A pixel is considered to belong to a coherently colored region if its color is equal or similar to the colors of a pre-specified minimum number of neighboring pixels. Furthermore, a texture feature-based representation of an image is based on the assumption that each perceptually significant texture is composed of large numbers of repetitions of the same color transition(s). Therefore, by identifying the frequently occurring color transitions and analyzing their textural properties, perceptually significant textures can be extracted and represented. For each agglomerated region (formed by the pixels from all the background regions in a sub-event), a set of dominant colors and textures are generated that describe the region. Dominant colors and textures are those that occupy a significant proportion (according to a defined threshold) of the overall pixels. The similarity of two images is computed as the similarity of their significant color and texture features as defined in U.S. Pat. No. 6,480,840.

Video images can be processed using the same steps as still images by extracting key-frames from the video sequence and using these as the still images representing the video. There are many published methods for extracting key-frames from video. As an example, Calic and Izquierdo propose a real-time method for scene change detection and key-frame extraction by analyzing statistics of the macro-block features extracted from the MPEG compressed stream in “Efficient Key-Frame Extraction and Video Analysis” published in IEEE International Conference on Information Technology: Coding and Computing, 2002.

Referring to FIG. 4, the color and texture features derived from each sub-event forms a data point in the feature space. These data points are clustered into groups with similar features 130. A simple clustering algorithm that produces these groups is listed as follows, where the reference point can be the mean value of points in the cluster:
0. Initialize by picking a random data point as a cluster of one with itself as the reference point.
1. For each new data point,
2. Find distances to reference points of existing clusters
3. If (minimum distance<threshold)
4. Add to cluster with minimum distance
5. Update reference point for the cluster in 4.
6. else Create new cluster with data point

In addition, text can be used as a feature and detected in image backgrounds using published methods such as “TextFinder: An Automatic System to Detect and Recognize Text in Images,” by Wu et al in IEEE Transactions on Pattern Analysis & Machine Intelligence, November 1999, pp. 1224-1228. The clustering process can also use matches in text found in image backgrounds to decrease the distance between those images from the distance computed by color and texture alone.

Referring to FIG. 4, the clusters are stored in index tables 140 that associate a unique location with the images in the cluster. Since these images have similar backgrounds, they are likely to have been captured at the same location. These clusters of images can be displayed on a display so that users can view the clusters and, optionally, the user can be prompted to provide a text label 150 to identify the location depicted by each cluster (e.g. “Paris”, “Grandma's house”). The user labels will be different for different locations, but clusters that depict the same location (even though there is no underlying image similarity detected), may be labeled with the same text by the user. This text label 150 is used to tag all images in that cluster. Additionally, the location labels can also be used to automatically caption the images. The text label 150 can be stored in association with the image(s) for later use to find or annotate the image(s).

The index tables 140 mapping a location (that may or may not have been labeled by the user) to images can be used when the user searches their image collection to find images taken at a given location. There can be multiple ways of searching. The user can provide an example image to find other images taken at the same or similar location. In this case, the system searches the collection by using the index tables 140 to retrieve the other images from the cluster that the example image belongs to. Alternatively, if the user has already labeled the clusters, they can use those labels as queries during a text-based search to retrieve these images. In this case, the search of the image collection involves retrieving all images in clusters with a label matching the query text. The user may also find images with similar location within a specific event, by providing an example image and limiting the search to that event.

It should also be clear that any number of features can be searched in the background regions—color and texture being used as examples in this description. For example, features can include information from camera meta-data stored in image files such as capture date and time or whether the flash fired. Features can also include labels generated by other ways—for example, matching the landmark in the background to a known image of the Eiffel Tower or determining who is in the image using face recognition technology. If any images in a cluster have attached GPS coordinates, these can be used as a feature in other images in the cluster.

The invention has been described in detail with particular reference to certain preferred embodiments thereof, but it will be understood that variations and modifications can be effected within the spirit and scope of the invention.

### PARTS LIST

10 images
20 background area
30 grouping by color and texture similarity step
40 common backgrounds
42 indexes generated
50 detecting people
55 images
60 locating vehicles
65 image
70 main subject regions
75 locating a sub-set of regions
80 image
90 image background
95 face region
100 clothing region
105 background region
110 locating events and sub-events
120 computing description for sub-event step
130 clustering backgrounds based on similarity step
140 storing clusters in index tables step
150 text labels

1. A method of identifying a particular background feature in a digital image, and using such feature to identify images in a collection of digital images that are of interest, comprising:
a) using the digital image for determining one or more background region(s), with the rest of the image region being the non-background region;
b) analyzing the background region(s) to determine one or more features which are suitable for searching the collection; and
c) using the one or more features to search the collection and identifying those digital images in the collection that have the one or more features.

2. The method of claim 1, wherein the non-background region(s) contains one or more persons, and determining the presence of such person(s) by using facial detection.

3. The method of claim 1, wherein the non-background region(s) contains one or more vehicles, and determining the presence of such vehicle(s) by using vehicle detection.

4. The method of claim 1, wherein step a) includes:
i) determining one or more non-background region(s); and
ii) assuming that the remaining regions are background regions.

5. The method of claim 4, wherein the non-background region(s) contains one or more persons, and determining the presence of such person(s) by using facial detection.

6. The method of claim 4, wherein the non-background region(s) contains one or more vehicles, and determining the presence of such vehicle(s) by using vehicle detection.

7. The method of claim 1, wherein the features include a color or texture.

8. A method of identifying a particular background feature in a digital image, and using such feature to identify images in a collection of digital images that are of interest, comprising:
a) using the digital image for determining one or more background region(s) and one or more non-background region(s);
b) analyzing the background region(s) to determine color or texture which is suitable for searching the collection;
c) clustering images based on the color or texture of their background regions;
d) labeling the clusters and storing the labels in a database associated with the identified digital images; and
e) using the labels to search the collection.

9. The method of claim 8, wherein the label refers to the location where the identified digital images were captured.

10. The method of claim 8, wherein the label is produced by a user after viewing the identified digital images on a display.
